(19) United States
(12) Patent Application Publication
(10) Pub. No.: US 2006/0144420 A1
(43) Pub. Date: Jul. 6, 2006

(54) Apparatus and method for manufacturing semiconductor device

(76) Inventors: Hirokazu Yokoi, Osaka (JP); Norishige Aoki, Kyoto (JP)

Correspondence Address: MCDERMOTT WILL & EMERY LLP, 600 13TH STREET, N.W., WASHINGTON, DC, 20005-3096, US

(21) Appl. No.: 11/289,720

(22) Filed: Nov. 30, 2005

(30) Foreign Application Priority Data
Jan. 5, 2005 (JP) 2005-000416

(51) Int. Cl. C23G 1/00; B08B 7/04; B08B 3/00

(52) U.S. Cl. 134/2; 134/84; 134/137; 134/61; 134/37

(57) ABSTRACT

An apparatus for manufacturing a semiconductor device performs wet cleaning of a semiconductor wafer in a cleaning chamber, transfer of the wet-cleaned semiconductor wafer into a drying chamber and drying of the semiconductor wafer in the drying chamber. The apparatus includes an atmosphere control means for controlling the atmosphere near the surface of the semiconductor wafer by introducing liquid inert gas onto the surface of the semiconductor wafer which has been wet-cleaned in the cleaning chamber and a transfer means for transferring the semiconductor wafer into the drying chamber in the atmosphere controlled by the atmosphere control means. The atmosphere control means introduces the liquid inert gas such that the surface of the semiconductor wafer is covered with the liquid inert gas and evaporated liquid inert gas.

### CROSS-REFERENCE TO RELATED APPLICATION

This non-provisional application claims priority under 35 U.S.C. §119(a) of Japanese Patent Application No. 2005-000416 filed in Japan on Jan. 5, 2005, the entire contents of which are hereby incorporated by reference.

### BACKGROUND OF THE INVENTION

1. Field of the Invention

The present invention relates to an apparatus and a method for manufacturing an electronic device, particularly to an apparatus and a method for manufacturing a semiconductor device including a semiconductor substrate and an apparatus and a method for manufacturing electronic devices including glass substrates for liquid crystal display devices and glass substrates for plasma display devices.

2. Description of Related Art

Among various steps for manufacturing semiconductor devices, one of the very important steps is cleaning.

The cleaning is generally carried out by a cleaning step and a drying step. In the cleaning step, a semiconductor wafer is treated with various chemical solutions for cleaning and then treated with pure water for rinsing. In the subsequent drying step, water is removed from the surface of the rinsed semiconductor wafer.

Hereinafter, a detailed explanation of a method for drying the semiconductor wafer will be provided.

An example of the method for drying the semiconductor wafer is spin drying.

According to the spin drying method, a semiconductor wafer held in a horizontal position is rotated at high speed to remove water from the surface of the semiconductor wafer by centrifugation, thereby drying the semiconductor wafer.

In the spin drying method, however, silicic acid (H₂SiO₃) is generated by a reaction among water, oxygen and silicon as represented by the following equation (1) and dissolved into the water. As silicic acid is deposited on the surface of the semiconductor wafer after the removal of water, a stain called a water mark may sometimes remain on the surface of the semiconductor wafer.
H₂O+O₂+Si→H₂SiO₃→HSiO₃⁻+H⁺ (1)

The deposit brings about a decrease in yield of the semiconductor device. Therefore, in the cleaning, it is critically important to dry the semiconductor wafer without forming the water mark on the surface of the semiconductor wafer.

Hereinafter, a method for drying the semiconductor wafer which does not form the water mark on the surface of the semiconductor wafer will be explained.

After the cleaning, a liquid film made of pure water is formed on the surface of the semiconductor wafer, and then an atmosphere shield plate is arranged near the semiconductor wafer to face the liquid film on the semiconductor wafer.

Then, a huge amount of nitrogen gas is supplied to a gap between the semiconductor wafer and the atmosphere shield plate to replace oxygen gas in the gap with the nitrogen gas.

In this way, the surface of the semiconductor wafer is covered with the liquid film and the nitrogen gas is supplied to remove oxygen from the atmosphere between the semiconductor wafer and the atmosphere shield plate. Thereafter, the semiconductor wafer is dried.

Since oxygen does not exist in the atmosphere between the semiconductor wafer and the atmosphere shield plate, the reaction represented by the equation (1) does not occur. Accordingly, the water mark is not formed on the surface of the semiconductor wafer in the drying step of the cleaning.

Thus, since oxygen gas is removed from the atmosphere near the surface of the semiconductor wafer, the semiconductor wafer is dried without forming the water mark on the surface of the semiconductor wafer.

If the semiconductor wafer is provided with a fine pattern formed thereon, the water mark is easily formed because water is likely to remain on the fine pattern.

Therefore, in addition to the huge amount of nitrogen gas, a huge amount of IPA (isopropyl alcohol) vapor is also supplied into the atmosphere between the semiconductor wafer and the atmosphere shield plate. As the IPA vapor volatilizes from the atmosphere between the semiconductor wafer and the atmosphere shield plate, water is removed from the surface of the semiconductor wafer.

If the semiconductor wafer is rotated at high speed while the huge amount of nitrogen gas and the huge amount of IPA vapor are supplied in the gap between the semiconductor wafer and the atmosphere shield plate, the removal of water is carried out more favorably (for example, see Japanese Unexamined Patent Publication No. 2004-119717).

The conventional methods for drying the semiconductor wafer, however, have the following problems.

For example, when the semiconductor wafer is rotated at high speed while the huge amount of nitrogen gas and the huge amount of IPA vapor are supplied in the gap between the semiconductor wafer and the atmosphere shield plate as described above, water droplets separated from the surface of the semiconductor wafer and the IPA vapor adhere to the atmosphere shield plate and then fall onto the surface of the semiconductor wafer. As a result, the water droplets and the IPA vapor re-adhere to the surface of the semiconductor wafer.

When the water droplets fall onto the surface of the semiconductor wafer, particles and contaminants contained in water or those which have been adhered to the atmosphere shield plate may adhere to the surface of the semiconductor wafer.

Further, since the huge amount of IPA vapor is used in the conventional drying methods, risk of fire, safety of operator and environmental issues are concerned.

### SUMMARY OF THE INVENTION

In view of the above, an object of the present invention is to provide an apparatus and a method for manufacturing a semiconductor device which make it possible to dry the semiconductor wafer without forming the water mark on the surface of the semiconductor wafer. For that purpose, according to the present invention, oxygen is removed from the atmosphere near the surface of the semiconductor wafer without use of a special device such as the atmosphere shield plate or organic solvents such as the IPA vapor, thereby controlling the atmosphere to be suitable for drying the semiconductor wafer.

According to an aspect of the present invention, an apparatus for manufacturing a semiconductor device performs wet cleaning of a semiconductor wafer in a cleaning chamber, transfer of the wet-cleaned semiconductor wafer into a drying chamber and drying of the semiconductor wafer in the drying chamber and includes: an atmosphere control means for controlling the atmosphere near the surface of the semiconductor wafer by introducing liquid inert gas onto the surface of the semiconductor wafer which has been wet-cleaned in the cleaning chamber; and a transfer means for transferring the semiconductor wafer into the drying chamber in the atmosphere controlled by the atmosphere control means. The atmosphere control means introduces the liquid inert gas such that the surface of the semiconductor wafer is covered with the liquid inert gas and evaporated liquid inert gas.

In the apparatus for manufacturing a semiconductor device according to an aspect of the present invention, liquid inert gas is introduced onto the surface of the wet-cleaned semiconductor wafer. As the liquid inert gas reaches the boiling point and evaporates on the surface of the semiconductor wafer, a layer of evaporated inert gas is formed on the surface of the semiconductor wafer. Further, a layer of liquid inert gas is formed on the evaporated inert gas layer which has expanded in volume as if it lifts the liquid inert gas layer up.

Thus, the surface of the semiconductor wafer is covered with the evaporated inert gas layer while oxygen is removed from the atmosphere near the surface of the semiconductor wafer by cubical expansion by the evaporation of the liquid inert gas. Therefore, the atmosphere near the surface of the semiconductor wafer is controlled to be suitable for drying the semiconductor wafer.

In the apparatus for manufacturing a semiconductor device according to an aspect of the present invention, the semiconductor wafer is transferred into the drying chamber in the state where oxygen has been removed from the atmosphere near the surface of the semiconductor wafer.

By so doing, during the transfer of the semiconductor wafer into the drying chamber, mixing of oxygen into the atmosphere near the surface of the semiconductor wafer is prevented and drag-in of oxygen into the atmosphere in the drying chamber by the semiconductor wafer is also prevented.

Therefore, with the apparatus for manufacturing a semiconductor device according to an aspect of the present invention, the semiconductor wafer is dried without forming the water mark on the surface of the semiconductor wafer in the drying chamber.

The apparatus for manufacturing a semiconductor device according to an aspect of the present invention makes it possible to remove oxygen from the atmosphere near the surface of the semiconductor wafer without the need of providing the conventional atmosphere shield plate in a position opposing the surface of the semiconductor wafer.

Accordingly, the parts count for the apparatus for manufacturing a semiconductor device according to an aspect of the present invention is reduced, thereby reducing failure rate and manufacturing cost of the apparatus.

Since the atmosphere shield plate is not used, water droplets separated from the surface of the semiconductor wafer will not adhere to the atmosphere shield plate and fall onto the surface of the semiconductor wafer. Therefore, particles and contaminants contained in the atmosphere shield plate will not adhere to the surface of the semiconductor wafer.

That is, with the apparatus for manufacturing a semiconductor device according to an aspect of the present invention, the semiconductor wafer is dried without forming particles and contaminants on the surface of the semiconductor wafer. Therefore, semiconductor wafer is cleaned at a higher degree.

In the apparatus for manufacturing a semiconductor device according to an aspect of the present invention, oxygen is removed from the atmosphere near the surface of the semiconductor wafer without use of organic solvents such as IPA vapor. This eliminates the concerns of risk of fire, safety of operator and environmental issues involved with use of the IPA vapor.

As described above, with the apparatus for manufacturing a semiconductor device according to an aspect of the present invention, oxygen is removed from the atmosphere near the surface of the semiconductor wafer without providing the atmosphere shield plate in the manufacturing apparatus. Therefore, the failure rate and manufacturing cost of the apparatus are reduced and the semiconductor wafer after the wet cleaning is dried in a cleaner state. Thus, the apparatus for manufacturing a semiconductor device according to an aspect of the present invention makes it possible to decrease the manufacturing cost of the semiconductor device and increase the yield and reliability of the semiconductor device.

It is preferred that the apparatus for manufacturing a semiconductor device according to an aspect of the present invention further includes a drying means for drying the semiconductor wafer in the drying chamber under reduced pressure.

According to this feature, the semiconductor wafer is dried in the drying chamber in the state where oxygen is removed from the atmosphere near the surface of the semiconductor wafer and the pressure is reduced.

As a result, the semiconductor wafer is dried without forming the water mark on the surface of the semiconductor wafer and the inert gas is completely removed from the atmosphere near the surface of the semiconductor wafer.

In particular, when a fine pattern has been formed on the semiconductor wafer, water remaining on the surface of the semiconductor wafer after the wet cleaning is excellently removed.

In the apparatus for manufacturing a semiconductor device according to an aspect of the present invention, it is preferred that a member for holding the semiconductor wafer in the cleaning chamber is made of material having the same thermal conductivity and the same shrinkage factor as material for a substrate of the semiconductor wafer.

According to this feature, even when the liquid inert gas is supplied onto the semiconductor wafer in the cleaning chamber and the member for holding the semiconductor wafer is shrunk by the liquid inert gas, the semiconductor wafer is prevented from misaligning from the correct position.

Since the misalignment of the semiconductor wafer from the correct position is prevented, warp or crack of the semiconductor wafer in the cleaning chamber is prevented.

In the apparatus for manufacturing a semiconductor device according to an aspect of the present invention, it is preferred that a member of the transfer means and a member for holding the semiconductor wafer in the drying chamber are made of material having thermal conductivity which is the same as or higher than the thermal conductivity of material for a substrate of the semiconductor wafer.

According to this feature, during the transfer of the semiconductor wafer, the semiconductor wafer to which the liquid inert gas has been supplied is prevented from warp or crack caused by the liquid inert gas.

Further, in the step of drying the semiconductor wafer to which the liquid inert gas has been supplied in the drying chamber, warp or crack of the semiconductor wafer caused by the liquid inert gas is prevented.

According to an aspect of the present invention, a method for manufacturing a semiconductor device performs wet cleaning of a semiconductor wafer in a cleaning chamber, transfer of the wet-cleaned semiconductor wafer into a drying chamber and drying of the semiconductor wafer in the drying chamber and includes the steps of: controlling the atmosphere near the surface of the semiconductor wafer by introducing liquid inert gas onto the surface of the semiconductor wafer which has been wet-cleaned in the cleaning chamber; and transferring the semiconductor wafer into the drying chamber in the atmosphere controlled by the atmosphere control step. In the atmosphere control step, the liquid inert gas is introduced such that the surface of the semiconductor wafer is covered with the liquid inert gas and evaporated liquid inert gas.

In the method for manufacturing a semiconductor device according to an aspect of the present invention, liquid inert gas is introduced onto the surface of the wet-cleaned semiconductor wafer. As the liquid inert gas reaches the boiling point and evaporates on the surface of the semiconductor wafer, a layer of evaporated inert gas is formed on the surface of the semiconductor wafer. Further, a layer of liquid inert gas is formed on the evaporated inert gas layer which has expanded in volume as if it lifts the liquid inert gas layer up.

Thus, the surface of the semiconductor wafer is covered with the evaporated inert gas layer while oxygen is removed from the atmosphere near the surface of the semiconductor wafer by cubical expansion by the evaporation of the liquid inert gas. Therefore, the atmosphere near the surface of the semiconductor wafer is controlled to be suitable for drying the semiconductor wafer.

In the method for manufacturing a semiconductor device according to an aspect of the present invention, the semiconductor wafer is transferred into the drying chamber in the state where oxygen has been removed from the atmosphere near the surface of the semiconductor wafer.

By so doing, during the transfer of the semiconductor wafer into the drying chamber, mixing of oxygen into the atmosphere near the surface of the semiconductor wafer is prevented and drag-in of oxygen into the atmosphere in the drying chamber by the semiconductor wafer is also prevented.

Therefore, according to the method for manufacturing a semiconductor device according to an aspect of the present invention, the semiconductor wafer is dried without forming the water mark on the surface of the semiconductor wafer in the drying chamber.

The method for manufacturing a semiconductor device according to an aspect of the present invention makes it possible to remove oxygen from the atmosphere near the surface of the semiconductor wafer without the need of providing the conventional atmosphere shield plate in a position opposing the surface of the semiconductor wafer.

Accordingly, the parts count for the apparatus for manufacturing a semiconductor device according to an aspect of the present invention is reduced, thereby reducing failure rate and manufacturing cost of the apparatus.

Since the atmosphere shield plate is not used, water droplets separated from the surface of the semiconductor wafer will not adhere to the atmosphere shield plate and fall onto the surface of the semiconductor wafer. Therefore, particles and contaminants contained in the atmosphere shield plate will not adhere to the surface of the semiconductor wafer.

That is, according to the method for manufacturing a semiconductor device according to an aspect of the present invention, the semiconductor wafer is dried without forming particles and contaminants on the surface of the semiconductor wafer. Therefore, semiconductor wafer is cleaned at a higher degree.

In the method for manufacturing a semiconductor device according to an aspect of the present invention, oxygen is removed from the atmosphere near the surface of the semiconductor wafer without use of organic solvents such as IPA vapor. This eliminates the concerns of risk of fire, safety of operator and environmental issues involved with use of the IPA vapor.

As described above, in the method for manufacturing a semiconductor device according to an aspect of the present invention, oxygen is removed from the atmosphere near the surface of the semiconductor wafer without providing the atmosphere shield plate in the manufacturing apparatus. Therefore, the failure rate and manufacturing cost of the apparatus are reduced and the semiconductor wafer after the wet cleaning is dried in a cleaner state. Thus, the method for manufacturing a semiconductor device according to an aspect of the present invention makes it possible to decrease the manufacturing cost of the semiconductor device and increase the yield and reliability of the semiconductor device.

It is preferred that the method for manufacturing a semiconductor device according to an aspect of the present invention further includes the step of drying the semiconductor wafer in the drying chamber under reduced pressure after the transfer step.

According to this feature, the semiconductor wafer is dried in the drying chamber in the state where oxygen is removed from the atmosphere near the surface of the semiconductor wafer and the pressure is reduced.

As a result, the semiconductor wafer is dried without forming the water mark on the surface of the semiconductor wafer and the inert gas is completely removed from the atmosphere near the surface of the semiconductor wafer.

In particular, when a fine pattern has been formed on the semiconductor wafer, water remaining on the surface of the semiconductor wafer after the wet cleaning is excellently removed.

In the method for manufacturing a semiconductor device according to an aspect of the present invention, it is preferred that the atmosphere in the drying chamber is controlled at a positive pressure using inert gas during the transfer of the semiconductor wafer.

By so doing, during the transfer of the semiconductor wafer into the drying chamber, mixing of oxygen and water from the atmospheric air into the drying chamber is prevented.

As a result, the semiconductor wafer is dried without forming the water mark on the surface of the semiconductor wafer in the drying chamber.

As described above, in the apparatus and method for manufacturing a semiconductor device according to an aspect of the present invention, oxygen is removed from the atmosphere near the surface of the semiconductor wafer without providing the atmosphere shield plate in the manufacturing apparatus. Therefore, the failure rate and manufacturing cost of the apparatus are reduced and the semiconductor wafer after the wet cleaning is dried in a cleaner state. Thus, the apparatus and method for manufacturing a semiconductor device according to an aspect of the present invention makes it possible to decrease the manufacturing cost of the semiconductor device and increase the yield and reliability of the semiconductor device.

### BRIEF DESCRIPTION OF THE DRAWINGS

FIG. 1 is a sectional view illustrating the structure of a cleaning device in an apparatus for manufacturing a semiconductor device according to Embodiment 1 of the present invention.

FIG. 2 is a sectional view illustrating the structure of the apparatus for manufacturing a semiconductor device according to Embodiment 1 of the present invention.

FIG. 3 is a sectional view illustrating the structure of a cleaning device in an apparatus for manufacturing a semiconductor device according to Embodiment 2 of the present invention.

FIG. 4 is a sectional view illustrating the structure of the apparatus for manufacturing a semiconductor device according to Embodiment 2 of the present invention.

### DETAILED DESCRIPTION OF THE INVENTION

Hereinafter, preferred embodiments of the present invention will be described with reference to the drawings.

### Embodiment 1

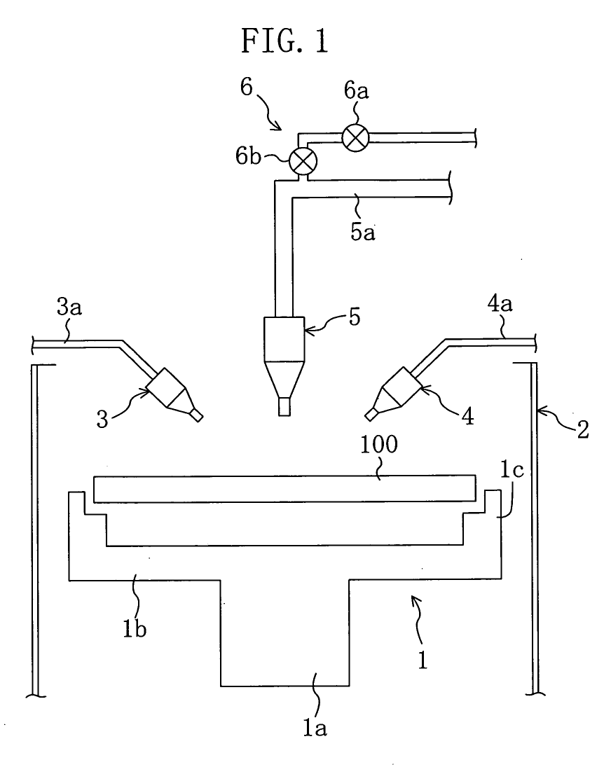

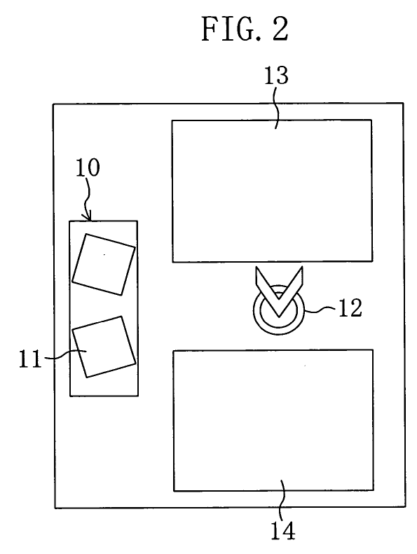

Hereinafter, referring to FIGS. 1 and 2, an explanation of an apparatus for manufacturing a semiconductor device according to Embodiment 1 of the present invention will be provided.

First, a cleaning device in the apparatus for manufacturing a semiconductor device according to Embodiment 1 will be described with reference to FIG. 1.

FIG. 1 is a sectional view illustrating the structure of the cleaning device in the apparatus for manufacturing a semiconductor device according to Embodiment 1 of the present invention.

Specifically, the cleaning device is a single-wafer cleaning device for cleaning semiconductor wafers one by one.

As shown in FIG. 1, the cleaning device in the semiconductor device manufacturing apparatus according to Embodiment 1 includes a spin chuck 1 which holds a semiconductor wafer 100 in a horizontal position and rotates the semiconductor wafer 100 about a rotation axis which is a vertical axis passing the center of the semiconductor wafer 100.

The spin chuck 1 includes a rotation shaft 1a extending along the vertical axis, a spin base 1b provided on the top of the rotation shaft 1a and a plurality of chuck pins 1c arranged at the edge of the spin base 1b. The spin chuck 1 holds and rotates the semiconductor wafer 100 in a horizontal position.

The spin chuck 1 is placed in a cup 2 which prevents the droplets of a chemical solution supplied to the semiconductor wafer 100 from scattering while the semiconductor wafer 100 rotates.

A chemical solution supply nozzle 3, a pure water supply nozzle 4 and an inert gas supply nozzle 5 are arranged above the spin chuck 1. The supply nozzles are connected to corresponding supply lines, respectively. Specifically, the chemical solution supply nozzle 3 is connected to a chemical solution supply line 3a, the pure water supply nozzle 4 is connected to a pure water supply line 4a and the inert gas supply nozzle 5 is connected to an inert gas supply line 5a.

To the semiconductor wafer 100, a chemical solution is supplied from the chemical solution supply line 3a through the chemical solution supply nozzle 3, pure water is supplied from the pure water supply line 4a through the pure water supply nozzle 4 and liquid inert gas is supplied from the inert gas supply line 5a through the inert gas supply nozzle 5.

The chemical solution, pure water and liquid inert gas are supplied from the supply lines through the supply nozzles to the semiconductor wafer 100 which is rotatably held by the spin chuck 1.

The inert gas supply line 5a is provided with a reflux line 6 which puts the liquid inert gas evaporated before discharge onto the semiconductor wafer 100 back to the supply line 5a (source side). The reflux line 6 is provided with safety valves 6a and 6b which are opened when the pressure in the reflux line 6 reaches a certain level.

The surfaces of the inert gas supply line 5a and the reflux line 6 are covered with heat insulating material to prevent condensation and frost from forming on the surfaces of the inert gas supply line 5a and the reflux line 6.

Next, with reference to FIG. 2, an explanation of the apparatus for manufacturing a semiconductor device according to Embodiment 1 of the present invention will be provided.

FIG. 2 is a sectional view illustrating the structure of the apparatus for manufacturing a semiconductor device according to Embodiment 1 of the present invention.

The semiconductor device manufacturing apparatus according to Embodiment 1 of the present invention includes, as shown in FIG. 2, a load port 10, a container 11, a transfer robot 12, a cleaning device 13 and a drying chamber 14.

The transfer robot 12 is provided with a transfer arm (not shown) made of quartz.

The drying chamber 14 includes a holding pin (not shown), an inert gas supply part (not shown), a pipe using a vacuum pump (not shown) and a valve (not shown).

In the cleaning device 13, cleaning and atmosphere control are carried out. Subsequently, the semiconductor wafer 100 is transferred from the cleaning device 13 to the drying chamber 14 using the transfer arm of the transfer robot 12 (transfer is carried out), and then drying is carried out in the drying chamber 14.

The inert gas used in the apparatus for manufacturing a semiconductor device according to Embodiment 1 is liquid nitrogen, which is commonly used as material for pure nitrogen gas in semiconductor factories. In the following description, the liquid inert gas is referred to as liquid nitrogen and the liquid inert gas which is evaporated is referred to as nitrogen gas.

Hereinafter, an explanation of a method for manufacturing a semiconductor device according to Embodiment 1 of the present invention will be provided with reference to FIGS. 1 and 2.

First, cleaning is carried out.

In the cleaning step, the semiconductor wafer 100 transferred to the cleaning device 13 is subjected to wet cleaning using a chemical solution and pure water.

As shown in FIG. 2, the semiconductor wafer 100 is placed in the container 11 in the load port 10 and then transferred to the cleaning device 13 using the transfer arm of the transfer robot 12.

Then, a chemical solution is supplied onto the semiconductor wafer 100 in the cleaning device 13 from the chemical solution supply line 3a through the chemical solution supply nozzle 3.

Examples of the chemical solution supplied onto the surface of the semiconductor wafer 100 include a hydrofluoric acid solution, an ammonia solution, hydrogen peroxide water, a hydrochloric acid solution, a sulfuric acid solution, a phosphoric acid solution, ozone water and hydrogen water or a mixture of them.

The chemical solution is adjusted to have a desired concentration in a chemical solution source (not shown) of the chemical solution supply line 3a and then fed into the chemical solution supply line 3a.

The chemical solution fed into the chemical solution supply line 3a is discharged from the chemical solution supply nozzle 3 onto the semiconductor wafer 100 which is rotatably held by the spin chuck 1. At this time, the semiconductor wafer 100 is rotated by the spin chuck 1 at the desired number of revolutions, specifically, about 500 to 3000 rpm.

The chemical solution discharged onto the semiconductor wafer 100 flows toward the edge of the semiconductor wafer 100 under centrifugal force applied by the rotation of the semiconductor wafer 100. As the chemical solution is spread over the entire surface of the semiconductor wafer 100, the semiconductor wafer 100 is uniformly cleaned.

After the wet cleaning of the semiconductor wafer 100 with the chemical solution, the supply of the chemical solution to the semiconductor wafer 100 through the chemical solution supply nozzle 3 is stopped.

Then, in the cleaning device 13, pure water is supplied from the pure water supply line 4a to the wet-cleaned semiconductor wafer 100 through the pure water supply nozzle 4 for desired time. At this time, the semiconductor wafer 100 is rotated by the spin chuck 1 at the desired number of revolutions.

Pure water supplied onto the semiconductor wafer 100 flows toward the edge of the semiconductor wafer 100 under centrifugal force applied by the rotation of the semiconductor wafer 100. As the pure water is spread over the entire surface of the semiconductor wafer 100, the chemical solution remaining on the wet-cleaned semiconductor wafer 100 is completely washed away.

After the wet cleaning of the semiconductor wafer 100 with pure water (rinsing), the supply of pure water to the semiconductor wafer 100 through the pure water supply nozzle 4 is stopped.

In this manner, the cleaning of the semiconductor wafer 100 is achieved by wet cleaning with the chemical solution and pure water.

Next, atmosphere control is carried out.

In the atmosphere control process, liquid nitrogen is supplied onto the semiconductor wafer 100 which has been cleaned in the cleaning device 13 such that the atmosphere near the surface of the semiconductor wafer 100 is controlled to be suitable for drying.

At the same time when the supply of pure water to the semiconductor wafer 100 is stopped, liquid nitrogen is supplied from the inert gas supply line 5a through the inert gas supply nozzle 5 to the semiconductor substrate 100 which has been wet-cleaned with the chemical solution and pure water for desired time. At this time, the semiconductor wafer 100 is rotated by the spin chuck 1 at the desired number of revolutions.

Specifically, liquid nitrogen is supplied from the inert gas supply line 5a through the inert gas supply nozzle 5 at a flow rate of about 1.0 L/min and the number of revolutions of the semiconductor wafer 100 rotated by the spin chuck 1 is about 500 rpm.

Most of liquid nitrogen supplied to the semiconductor wafer 100 through the inner gas supply nozzle 5 reaches the surface of the semiconductor wafer 100 as it is, though part of which evaporates before reaching the surface of the semiconductor wafer 100.

As the atmosphere near the surface of the semiconductor wafer 100 is at room temperature, liquid nitrogen which first arrived at the surface of the semiconductor wafer 100 reaches the boiling point and evaporates.

The liquid nitrogen which has arrived at the surface of the semiconductor wafer 100 evaporates and forms a layer of nitrogen gas on the surface of the semiconductor wafer 100. When evaporates, liquid nitrogen increases the volume about 650 times. Therefore, oxygen in the atmosphere near the surface of the semiconductor wafer 100 is eliminated by the pressure of cubical expansion of liquid nitrogen.

Since liquid nitrogen has evaporated and expanded in volume to form the nitrogen gas layer, liquid nitrogen which is subsequently supplied to the semiconductor wafer 100 is formed into a liquid nitrogen layer lifted by the nitrogen gas layer.

In this manner, liquid nitrogen supplied from the inert gas supply line 5a through the inert gas supply nozzle 5 is formed into the nitrogen gas layer on the semiconductor wafer 100 and the liquid nitrogen layer is formed on the nitrogen gas layer.

As described above, in the atmosphere control step, liquid nitrogen is supplied onto the semiconductor wafer 100 which is rotated by the spin chuck 1 at the desired number of revolutions.

Liquid nitrogen which has reached the semiconductor wafer 100 flows toward the edge of the semiconductor wafer 100 under centrifugal force applied by the rotation of the semiconductor wafer 100. As a result, the liquid nitrogen which has reached the semiconductor wafer 100 is transferred without evaporating to a portion of the surface of the semiconductor wafer 100 where the nitrogen gas layer is not formed yet, and then reaches the boiling point on that portion to evaporate. This makes it possible to supply liquid nitrogen over the entire surface of the semiconductor wafer 100, whereby the entire surface of the semiconductor wafer 100 is covered with the nitrogen gas layer.

Thus, the surface of the semiconductor wafer 100 is entirely covered with the nitrogen gas layer while oxygen is removed from the atmosphere near the surface of the semiconductor wafer 100 by the pressure of the cubical expansion by evaporation of liquid nitrogen and the centrifugal force applied by the rotation of the semiconductor wafer 100. Therefore, the atmosphere near the surface of the semiconductor wafer is controlled to be suitable for drying the semiconductor wafer.

The member which rotatably holds the semiconductor wafer 100 in the cleaning device 13, i.e., the spin chuck 1, is made of material having the same thermal conductivity and the same shrinkage factor as material for a substrate of the semiconductor wafer 100.

Even if the member for holding the semiconductor wafer 100 (e.g., chuck pins 1c) is shrunk by supplying liquid nitrogen onto the semiconductor wafer 100, the semiconductor wafer 100 is prevented from becoming misaligned from the correct position.

Since the misalignment of the semiconductor wafer 100 from the correct position is prevented, the semiconductor wafer 100 is rotated at high speed by the spin chuck 1 in the cleaning device 13 without warp or crack of the semiconductor wafer 100.

The surface of the semiconductor wafer 100 is cooled s liquid nitrogen is supplied thereto. The surface of the semiconductor wafer 100 may be cooled to a temperature below the boiling point of liquid nitrogen. In such a case, liquid nitrogen cannot reach the boiling point even if it comes to the surface of the semiconductor wafer 100 and therefore the surface of the semiconductor wafer 100 cannot be entirely covered with the nitrogen gas layer.

On account of this, the inert gas supply nozzle 5 may swing above the semiconductor wafer 100 while supplying liquid nitrogen onto the semiconductor wafer 100.

By so doing, liquid nitrogen is quickly supplied over the entire surface of the semiconductor wafer 100 before the surface of the semiconductor wafer 100 is cooled to a temperature below the boiling point of liquid nitrogen. Thus, liquid nitrogen arrived at the surface of the semiconductor wafer 100 reaches the boiling point and evaporates on the surface of the semiconductor wafer 100. As a result, the entire surface of the semiconductor wafer 100 is covered with the nitrogen gas.

If no patterns are formed or a relatively large pattern is formed on the semiconductor wafer 100, supplying liquid nitrogen onto the semiconductor wafer 100 makes it possible to remove not only oxygen but also water from the atmosphere near the surface of the semiconductor wafer 100.

After the atmosphere control on the semiconductor wafer 100 using liquid nitrogen, the rotation of the semiconductor wafer 100 by the spin chuck 1 is stopped and then the supply of liquid nitrogen to the semiconductor wafer 100 through the inert gas supply nozzle 5 is also stopped.

Thus, the atmosphere control is achieved by eliminating oxygen from the atmosphere near the surface of the semiconductor wafer 100.

Subsequently, transfer of the semiconductor wafer is carried out.

In the transfer step, the semiconductor wafer 100 is transferred from the cleaning device 13 to the drying chamber 14.

In the state where oxygen has been removed from the atmosphere near the surface of the semiconductor wafer 100, the semiconductor wafer 100 is transferred from the cleaning device 13 to the drying chamber 14 (not detailed in the figure) using the transfer arm of the transfer robot 12 shown in FIG. 2.

At this time, the surface of the semiconductor wafer 100 is kept covered with the nitrogen gas layer and the liquid nitrogen layer. Therefore, during the transfer, mixing of oxygen into the atmosphere near the surface of the semiconductor wafer 100 is prevented and drag-in of oxygen in the drying chamber 14 by the semiconductor wafer 100 is also prevented.

The drying chamber 14 into which the semiconductor wafer 100 is transferred is filled with nitrogen gas using the inert gas supply part of the drying chamber 14 and controlled at a positive pressure. By so doing, oxygen and water contained in the atmospheric air are prevented from entering the drying chamber 14 during the transfer.

The transfer arm of the transfer robot 12 is made of highly thermo-conductive metal or silicon-based material which has the same thermal conductivity as the material for a substrate of the semiconductor wafer 100. Therefore, warp or crack of the semiconductor wafer 100 caused by liquid nitrogen is prevented.

Thus, the transfer of the semiconductor wafer 100 from the cleaning device 13 to the drying chamber 14 is achieved.

Next, drying is carried out.

In the drying step, the semiconductor wafer 100 which has been transferred into the drying chamber 14 is dried under reduced pressure.

As shown in FIG. 2, the pressure in the drying chamber 14 is reduced to about 1.0 Pa using the pipe and the valve of the drying chamber 14 and the semiconductor wafer 100 is kept under the reduced pressure using the holding pin for desired time, e.g., about 60 seconds.

According to the method for manufacturing a semiconductor device of Embodiment 1 of the present invention, the semiconductor wafer 100 is dried in the drying chamber 14 in the state where oxygen is removed from the atmosphere near the surface of the semiconductor wafer 100 and the pressure is reduced.

As a result, the semiconductor wafer 100 is dried without forming the water mark on the surface of the semiconductor wafer 100 and the nitrogen gas is completely removed from the atmosphere near the surface of the semiconductor wafer 100.

In particular, when a fine pattern has been formed on the semiconductor wafer 100, water remaining on the surface of the semiconductor wafer 100 after the wet cleaning is excellently removed.

After the semiconductor wafer 100 is dried under reduced pressure, the drying chamber 14 is filled with nitrogen gas using the inert gas supply part of the drying chamber 14 such that the atmosphere in the drying chamber 14 returns to the atmospheric pressure.

Then, the semiconductor wafer 100 is transferred from the drying chamber 14 to the container 11 using the transfer arm of the transfer robot 12.

Thus, the drying of the semiconductor wafer 100 is achieved under the reduced pressure.

According to the apparatus and method for manufacturing a semiconductor device of Embodiment 1 of the present invention, liquid nitrogen is supplied onto the surface of the semiconductor wafer 100 after the wet cleaning, thereby forming a nitrogen gas layer on the surface of the semiconductor wafer 100 and a liquid nitrogen layer on the nitrogen gas layer.

By so doing, the surface of the semiconductor wafer 100 is covered with the nitrogen gas layer while oxygen is removed from the atmosphere near the surface of the semiconductor wafer 100 by cubical expansion of liquid nitrogen during evaporation. As a result, the atmosphere near the surface of the semiconductor wafer 100 is controlled to be suitable for drying the semiconductor wafer 100.

According to the apparatus and method for manufacturing a semiconductor device of Embodiment 1 of the present invention, the semiconductor wafer 100 is transferred into the drying chamber 14 while oxygen has been removed from the atmosphere near the surface of the semiconductor wafer 100.

Therefore, during the transfer of the semiconductor wafer 100 to the drying chamber 14, mixing of oxygen in the atmosphere near the surface of the semiconductor wafer 100 is prevented and drag-in of oxygen in the atmosphere in the drying chamber 14 by the semiconductor wafer 100 is also prevented.

According to the apparatus and method for manufacturing a semiconductor device of Embodiment 1 of the present invention, the atmosphere in the drying chamber 14 into which the semiconductor wafer 100 is transferred is controlled to a positive pressure using nitrogen gas.

Therefore, the semiconductor wafer 100 is transferred to the drying chamber 14 while mixing of oxygen and water into the drying chamber 14 from the atmospheric air is prevented.

Thus, according to the apparatus and method for manufacturing a semiconductor device of Embodiment 1 of the present invention, oxygen will not be mixed in the drying chamber 14 during the transfer of the semiconductor wafer 100 to the drying chamber 14.

Therefore, according to the apparatus and method for manufacturing a semiconductor device of Embodiment 1 of the present invention, the semiconductor wafer 100 is dried in the drying chamber 14 in the state where oxygen is removed from the atmosphere near the surface of the semiconductor wafer 100 and the pressure is reduced.

As a result, the semiconductor wafer 100 is dried without forming the water mark on the surface of the semiconductor wafer 100 and nitrogen gas is completely removed from the atmosphere near the surface of the semiconductor wafer 100.

According to the apparatus and method for manufacturing a semiconductor device of Embodiment 1 of the present invention, oxygen is removed from the atmosphere near the surface of the semiconductor wafer 100 without the need of providing the conventional atmosphere shield plate in a position opposing the surface of the semiconductor wafer 100.

Thus, the parts count for the semiconductor device manufacturing apparatus of Embodiment 1 of the present invention is reduced, thereby decreasing failure rate and manufacturing cost of the apparatus.

Since the atmosphere shield plate is not used, water droplets separated from the surface of the semiconductor wafer 100 will not adhere to the atmosphere shield plate and fall onto the surface of the semiconductor wafer 100. Therefore, particles and contaminants contained in the atmosphere shield plate will not adhere to the surface of the semiconductor wafer 100.

That is, according to the apparatus and method for manufacturing a semiconductor device of Embodiment 1 of the present invention, the semiconductor wafer 100 is dried without generating particles and contaminants on the surface of the semiconductor wafer 100. Therefore, the semiconductor wafer 100 is cleaned at a higher degree.

According to the apparatus and method for manufacturing a semiconductor device of Embodiment 1 of the present invention, oxygen is removed from the atmosphere near the surface of the semiconductor wafer 100 without use of organic solvents such as IPA vapor. This eliminates the concerns of risk of fire, safety of operator and environmental issues involved with use of the IPA vapor.

As described above, according to the apparatus and method for manufacturing a semiconductor device of Embodiment 1 of the present invention, oxygen is removed from the atmosphere near the surface of the semiconductor wafer 100 without providing the atmosphere shield plate in the manufacturing apparatus. Therefore, the failure rate and manufacturing cost of the apparatus are reduced and the semiconductor wafer 100 after the wet cleaning is dried in a cleaner state. Thus, the apparatus and method for manufacturing a semiconductor device of Embodiment 1 of the present invention make it possible to decrease the manufacturing cost of the semiconductor device and increase the yield and reliability of the semiconductor device.

The apparatus for manufacturing a semiconductor device according to Embodiment 1 of the present invention may include a notch aligner in place of the load port 10, container 11, transfer arm 12, cleaning device 13 and drying chamber 14.

In the cleaning step of the method for manufacturing a semiconductor device according to the present embodiment, physical force may be applied to the semiconductor wafer 100 by megasonic waves or a brush in addition to the rotation of the semiconductor wafer 100 by the spin chuck 1.

In the atmosphere control step of the method for manufacturing a semiconductor device according to the present embodiment, the flow rate of liquid nitrogen supplied onto the semiconductor wafer 100, treatment time and the number of revolutions of the semiconductor wafer 100 by the spin chuck 1 may be changed as required depending on the size of the semiconductor wafer 100 or other.

Further, in the atmosphere control step of the method for manufacturing a semiconductor device according to the present embodiment, another inert gas supply nozzle for the bottom surface of the wafer may be provided in addition to the inert gas supply nozzle 5 such that liquid inert gas is supplied simultaneously to the top and bottom surfaces of the semiconductor wafer 100.

### Embodiment 2

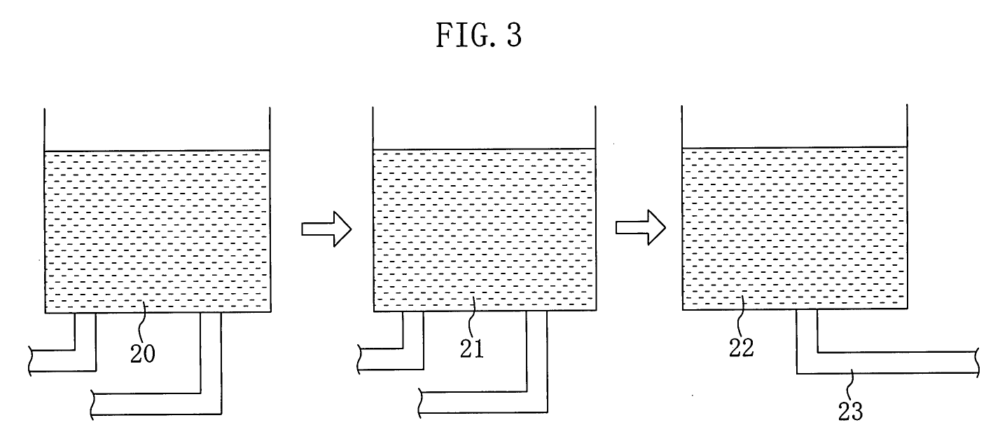

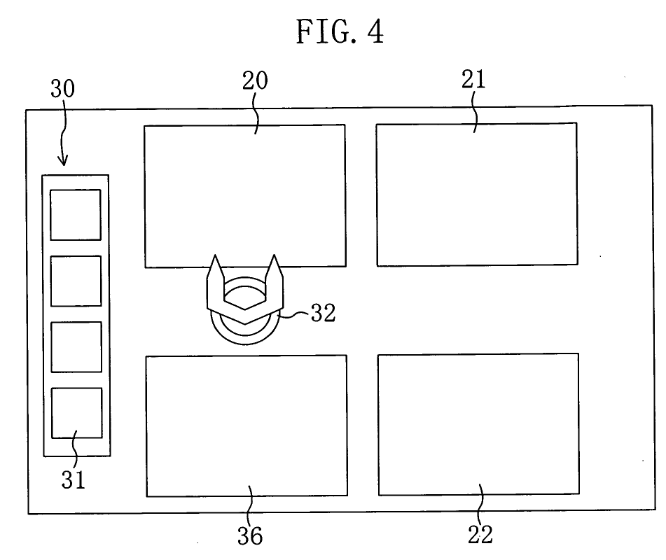

Hereinafter, with reference to FIGS. 3 and 4, an explanation of an apparatus for manufacturing a semiconductor device according to Embodiment 2 of the present invention will be provided.

First, a cleaning device in the apparatus for manufacturing a semiconductor device according to Embodiment 2 will be described with reference to FIG. 3.

FIG. 3 is a sectional view illustrating the structure of the cleaning device in the apparatus for manufacturing a semiconductor device according to Embodiment 2.

Specifically, the cleaning device is a batch cleaning device for cleaning a batch of semiconductor wafers.

As shown in FIG. 3, the cleaning device in the semiconductor device manufacturing apparatus according to Embodiment 2 includes a chemical solution bath 20, a pure water bath 21 and an inert gas bath 22. An inert gas supply line 23 is connected to the inert gas bath 22.

In the chemical solution bath 20, semiconductor wafers are immersed in the chemical solution for desired time to perform wet cleaning of the semiconductor wafers. In the pure water bath 21, the semiconductor wafers are immersed in pure water to rinse the semiconductor wafers with the pure water. Further, in the inert gas bath 22, the semiconductor wafers are immersed in liquid inert gas contained in the inert gas bath 22 to remove oxygen from the atmosphere near the surfaces of the semiconductor wafers.

Next, with reference to FIG. 4, an explanation of the apparatus for manufacturing a semiconductor device according to Embodiment 2 of the present invention will be provided.

FIG. 4 is a sectional view illustrating the structure of the apparatus for manufacturing a semiconductor device according to Embodiment 2 of the present invention.

The semiconductor device manufacturing apparatus according to Embodiment 2 of the present invention includes, as shown in FIG. 4, a load port 30, a container 31, a transfer robot 32, a cleaning solution bath 20, a pure water bath 21, an inert gas bath 22 and a drying chamber 36.

The transfer robot 32 is provided with a transfer arm (not shown) and the drying chamber 36 includes a holding pin (not shown), an inert gas supply part (not shown), a pipe using a vacuum pump (not shown) and a valve (not shown).

Cleaning is carried out in the chemical solution bath 20 and the pure water bath 21 and atmosphere control is carried out in the inert gas bath 22. After that, the semiconductor wafers are transferred from the inert gas bath 22 to the drying chamber 36 using the transfer arm of the transfer robot 32 (transfer is carried out), and then drying is carried out in the drying chamber 36.

Hereinafter, an explanation of a method for manufacturing a semiconductor device according to Embodiment 2 of the present invention will be provided with reference to FIGS. 3 and 4.

First, cleaning is carried out.

In the cleaning step, the semiconductor wafers transferred to the chemical solution bath 20 are subjected to wet cleaning using the chemical solution and then the semiconductor wafers transferred to the pure water bath 21 are subjected to rinsing with pure water.

As shown in FIG. 4, the semiconductor wafers are placed in the container 31 in the load port 30 and then transferred to the chemical solution bath 20 using the transfer arm of the transfer robot 32.

Then, the semiconductor wafers are immersed in the chemical solution in the chemical solution bath 20 for wet etching for desired time.

After the wet cleaning using the chemical solution, the semiconductor wafers are transferred to the pure water bath 21 using the transfer arm of the transfer robot 32.

Then, the semiconductor wafers are immersed in pure water in the pure water bath 21 for desired time such that the chemical solution remaining on the wet-cleaned semiconductor wafers is washed away.

Then, atmosphere control is carried out.

In the atmosphere control step, the wet-cleaned semiconductor wafers are immersed in liquid nitrogen contained in the inert gas bath 22 such that the atmosphere near the surfaces of the semiconductor wafers is controlled to be suitable for drying.

As shown in FIG. 4, the semiconductor wafers are transferred from the pure water bath 21 to the inert gas bath 22 using the transfer arm of the transfer robot 32.

Then, the semiconductor wafers are immersed in liquid nitrogen contained in the inert gas bath 22 for desired time. As a result, a nitrogen gas layer is formed on each of the surfaces of the semiconductor wafers and a liquid nitrogen layer is formed on the nitrogen gas layer.

As liquid nitrogen evaporates to form the nitrogen gas layer, oxygen is removed from the atmosphere near the surfaces of the semiconductor wafers by the pressure of cubical expansion of evaporated liquid nitrogen and each of the surfaces of the semiconductor wafers is entirely covered with the nitrogen gas layer. This makes it possible to control the atmosphere near the surfaces of the semiconductor wafers to be suitable for drying the semiconductor wafers.

Subsequently, transfer of the semiconductor wafers is carried out.

In the transfer step, the semiconductor wafers are transferred from the inert gas bath 22 to the drying chamber 36.

In the state where oxygen has been removed from the atmosphere near the surfaces of the semiconductor wafers, the semiconductor wafers are transferred from the inert gas bath 22 to the drying chamber 36 using the transfer arm of the transfer robot 36 shown in FIG. 4.

At this time, each of the surfaces of the semiconductor wafers is kept covered with the nitrogen gas layer and the liquid nitrogen layer. Therefore, during the transfer, mixing of oxygen into the atmosphere near the surfaces of the semiconductor wafers is prevented and drag-in of oxygen in the atmosphere in the drying chamber 36 by the semiconductor wafers is also prevented.

The drying chamber 36 into which the semiconductor wafers are transferred is filled with nitrogen gas using the inert gas supply part of the drying chamber 36 and controlled at a positive pressure. By so doing, oxygen and water contained in the atmospheric air are prevented from entering the drying chamber 36 during the transfer.

The transfer arm of the transfer robot 32 is made of highly thermo-conductive metal or silicon-based material which has the same thermal conductivity as the material for a substrate of the semiconductor wafer. Therefore, warp or crack of the semiconductor wafer caused by liquid nitrogen is prevented.

Next, drying is carried out.

In the drying step, the semiconductor wafers transferred into the drying chamber 36 are dried under reduced pressure.

As shown in FIG. 4, the pressure in the drying chamber 36 is reduced to about 1.0 Pa using the pipe and the valve of the drying chamber 36 and the semiconductor wafers are kept under the reduced pressure using the holding pin for desired time, e.g., about 60 seconds.

According to the method for manufacturing a semiconductor device of Embodiment 2 of the present invention, the semiconductor wafers are dried in the drying chamber 36 in the state where oxygen is removed from the atmosphere near the surfaces of the semiconductor wafers and the pressure is reduced.

As a result, the semiconductor wafers are dried without forming the water mark on the surfaces of the semiconductor wafers and the nitrogen gas is completely removed from the atmosphere near the surfaces of the semiconductor wafers.

In particular, when a fine pattern has been formed on the semiconductor wafer, water remaining on the surface of the semiconductor wafer after the wet cleaning is excellently removed.

After the semiconductor wafers are dried under reduced pressure, the drying chamber 36 is filled with nitrogen gas using the inert gas supply part of the drying chamber 36 such that the atmosphere in the drying chamber 36 returns to the atmospheric pressure.

Then, the semiconductor wafers are transferred from the drying chamber 36 to the container 31 using the transfer arm of the transfer robot 32.

According to the apparatus and method for manufacturing a semiconductor device of Embodiment 2 of the present invention, the semiconductor wafers after the wet-cleaning are immersed in liquid nitrogen contained in the inert gas bath 22, thereby forming a nitrogen gas layer on each of the surfaces of the semiconductor wafers and a liquid nitrogen layer on the nitrogen gas layer.

By so doing, each of the surfaces of the semiconductor wafers is covered with the nitrogen gas layer while oxygen is removed from the atmosphere near the surfaces of the semiconductor wafers by the cubical expansion of evaporated liquid nitrogen. As a result, the atmosphere near the surfaces of the semiconductor wafers is controlled to be suitable for drying the semiconductor wafers.

According to the apparatus and method for manufacturing a semiconductor device of Embodiment 2 of the present invention, the semiconductor wafers are transferred into the drying chamber 36 while oxygen has been removed from the atmosphere near the surfaces of the semiconductor wafers.

Therefore, during the transfer of the semiconductor wafers to the drying chamber 36, mixing of oxygen in the atmosphere near the surfaces of the semiconductor wafers is prevented and drag-in of oxygen in the atmosphere in the drying chamber 36 by the semiconductor wafers is also prevented.

According to the apparatus and method for manufacturing a semiconductor device of Embodiment 2 of the present invention, the atmosphere in the drying chamber 36 into which the semiconductor wafers are transferred is controlled to a positive pressure using nitrogen gas.

Therefore, the semiconductor wafers are transferred to the drying chamber 36 while mixing of oxygen and water into the drying chamber 36 from the atmospheric air is prevented.

Thus, according to the apparatus and method for manufacturing a semiconductor device of Embodiment 2 of the present invention, oxygen will not be mixed in the drying chamber 36 during the transfer of the semiconductor wafers to the drying chamber 36.

Therefore, according to the apparatus and method for manufacturing a semiconductor device of Embodiment 2 of the present invention, the semiconductor wafers are dried in the drying chamber 36 in the state where oxygen is removed from the atmosphere near the surfaces of the semiconductor wafers and the pressure is reduced.

As a result, the semiconductor wafers are dried without forming the water mark on the surfaces of the semiconductor wafers and nitrogen gas is completely removed from the atmosphere near the surfaces of the semiconductor wafers.

According to the apparatus and method for manufacturing a semiconductor device of Embodiment 2 of the present invention, oxygen is removed from the atmosphere near the surfaces of the semiconductor wafers without the need of providing the conventional atmosphere shield plate in a position opposing the surface of the semiconductor wafer.

Thus, the parts count for the semiconductor device manufacturing apparatus of Embodiment 2 of the present invention is reduced, thereby decreasing failure rate and manufacturing cost of the apparatus.

Since the atmosphere shield plate is not used, water droplets separated from the surface of the semiconductor wafer will not adhere to the atmosphere shield plate and fall onto the surface of the semiconductor wafer. Therefore, particles and contaminants contained in the atmosphere shield plate will not adhere to the surface of the semiconductor wafer.

That is, according to the apparatus and method for manufacturing a semiconductor device of Embodiment 2 of the present invention, the semiconductor wafers are dried without generating particles and contaminants on the surfaces of the semiconductor wafers. Therefore, the semiconductor wafers is cleaned at a higher degree.

According to the apparatus and method for manufacturing a semiconductor device of Embodiment 2 of the present invention, oxygen is removed from the atmosphere near the surfaces of the semiconductor wafers without use of organic solvents such as IPA vapor. This eliminates the concerns of risk of fire, safety of operator and environmental issues involved with use of the IPA vapor.

As described above, according to the apparatus and method for manufacturing a semiconductor device of Embodiment 2 of the present invention, oxygen is removed from the atmosphere near the surfaces of the semiconductor wafers without using the atmosphere shield plate in the manufacturing apparatus. Therefore, the failure rate and manufacturing cost of the manufacturing apparatus are reduced and the semiconductor wafers after the wet cleaning are dried in a cleaner state. Thus, the apparatus and method for manufacturing a semiconductor device of Embodiment 2 of the present invention make it possible to decrease the manufacturing cost of the semiconductor device and increase the yield and reliability of the semiconductor device.

The apparatus and method for manufacturing a semiconductor device according to Embodiments 1 and 2 of the present invention may include a plurality of cleaning devices and a plurality of drying devices (drying chambers) in consideration of throughput and the chemical solution used.

In the atmosphere control step of the method for manufacturing a semiconductor device according to Embodiments 1 and 2 of the present invention, liquid argon, liquid helium or other may be used in place of liquid nitrogen used as the liquid inert gas fed into the inert gas supply lines 5a and 23.

In the drying step of the method for manufacturing a semiconductor device according to Embodiments 1 and 2 of the present invention, the semiconductor wafer may be dried by heating with a halogen lamp.

As described above, the present invention is useful for an apparatus and a method for manufacturing a semiconductor device because the semiconductor wafer is dried without forming the water mark on the surface of the semiconductor wafer.

Thus, the present invention is expected to offer excellent effect on an apparatus and a method for manufacturing electronic devices using glass substrates for liquid crystal display devices and plasma display devices.

What is claimed is:

1. An apparatus for manufacturing a semiconductor device which performs wet cleaning of a semiconductor wafer in a cleaning chamber, transfer of the wet-cleaned semiconductor wafer into a drying chamber and drying of the semiconductor wafer in the drying chamber, the apparatus comprising:
an atmosphere control means for controlling the atmosphere near the surface of the semiconductor wafer by introducing liquid inert gas onto the surface of the semiconductor wafer which has been wet-cleaned in the cleaning chamber; and
a transfer means for transferring the semiconductor wafer into the drying chamber in the atmosphere controlled by the atmosphere control means, wherein
the atmosphere control means introduces the liquid inert gas such that the surface of the semiconductor wafer is covered with the liquid inert gas and evaporated liquid inert gas.

2. An apparatus for manufacturing a semiconductor device according to claim 1 further comprising a drying means for drying the semiconductor wafer in the drying chamber under reduced pressure.

3. An apparatus for manufacturing a semiconductor device according to claim 1, wherein
a member for holding the semiconductor wafer in the cleaning chamber is made of material having the same thermal conductivity and the same shrinkage factor as material for a substrate of the semiconductor wafer.

4. An apparatus for manufacturing a semiconductor device according to claim 1, wherein
a member of the transfer means and a member for holding the semiconductor wafer in the drying chamber are made of material having thermal conductivity which is the same as or higher than the thermal conductivity of material for a substrate of the semiconductor wafer.

5. A method for manufacturing a semiconductor device which performs wet cleaning of a semiconductor wafer in a cleaning chamber, transfer of the wet-cleaned semiconductor wafer into a drying chamber and drying of the semiconductor wafer in the drying chamber, the method comprising the steps of:
controlling the atmosphere near the surface of the semiconductor wafer by introducing liquid inert gas onto the surface of the semiconductor wafer which has been wet-cleaned in the cleaning chamber; and
transferring the semiconductor wafer into the drying chamber in the atmosphere controlled by the atmosphere control step, wherein
in the atmosphere control step, the liquid inert gas is introduced such that the surface of the semiconductor wafer is covered with the liquid inert gas and evaporated liquid inert gas.

6. A method for manufacturing a semiconductor device according to claim 5 further comprising the step of drying the semiconductor wafer in the drying chamber under reduced pressure after the transfer step.

7. A method for manufacturing a semiconductor device according to claim 5, wherein the atmosphere in the drying chamber is controlled at a positive pressure using inert gas during the transfer of the semiconductor wafer.
